(19) United States
(12) Patent Application Publication
(10) Pub. No.: US 2012/0123650 A1
(43) Pub. Date: May 17, 2012

(54) Agricultural harvesting machine

(76) Inventors: Norbert Diekhans, Guetersloh (DE); Jochen Huster, Guetersloh (DE); Frank Claussen, Greffen (DE)

(21) Appl. No.: 13/269,725

(22) Filed: Oct. 10, 2011

(30) Foreign Application Priority Data
Nov. 12, 2010 (DE) 10 2010 051 068.8

(51) Int. Cl. A01D 41/127; A01D 45/02; B02C 23/00; G06F 19/00

(52) U.S. Cl. 701/50; 241/101.3

(57) ABSTRACT

An agricultural harvesting machine comprising a chopping assembly for fragmenting crop, and a camera situated downstream of the chopping assembly in order to optically detect the fragmented crop and produce images of the fragmented crop, wherein the camera is connected to an image evaluation device which can be operated to detect edges in the generated images in order to deduce properties of the fragmented crop.

### CROSS-REFERENCE TO RELATED APPLICATION

The invention described and claimed hereinbelow is also described in German Patent Application DE 10 2010 051 068.8 filed on Nov. 12, 2010. This German Patent Application, whose subject matter is incorporated here by reference, provides the basis for a claim of priority of invention under 35 U.S.C. 119(a)-(d).

### BACKGROUND OF THE INVENTION

The invention relates to an agricultural harvesting machine comprising a chopping assembly for fragmenting crop, and a camera situated downstream of the chopping assembly relative to a crop flow being conveyed through the chopping assembly, which is used to optically detect the fragmented crop and produce images of the fragmented crop.

Self-harvesting forage harvesters are used preferably to harvest corn for silage, i.e. corn to be stored in a silo after harvesting. They pick up the crop to be harvested from the field using a front attachment and direct it to conveyor mechanisms, where compression between antagonistic compression rollers takes place. The compression rollers then convey the crop into a chopping assembly, in which the crop is cut (“chopped”) via interaction between a rotating chopper drum comprising cutting blades, and a stationary shear bar. Next, the crop travels through a conveyor chute in which a post-accelerator for accelerating the crop is disposed, and into a transfer device in order to be ejected onto a hauling vehicle travelling next to the forage harvester. During a corn harvest, in order to break open the energy-rich corn kernels and thereby make them digestible by animals, conditioning rollers are also disposed in the conveyor chute, between which the corn kernels are broken open.

To ensure good feed quality, the properties of the processed crop should be monitored during harvesting, if possible. Since simply driving the machine as well as observing and controlling the transfer process require a great deal of attention on the part of the driver, the ability to monitor the quality of chopped material in a machine-supported manner is a worthwhile goal.

Document EP 2 098 109 A1 makes known a forage harvester, in the case of which images of the chopped material produced by a camera disposed on the transfer device are evaluated. The crop particles are subjected to virtual sifting, wherein a distribution of the quantity of certain particle sizes can be determined by utilizing different grating widths of the virtual sieve. The quality of the chopped material cannot be determined adequately, however, simply on the basis of the particle sizes since further criteria play a role in the quality of chopped material.

### SUMMARY OF THE INVENTION

A problem addressed by the present invention is therefore that of providing an agricultural harvesting machine of the initially stated type, with which the quality of the fragmented crop can be determined in a differentiated manner and with comfortable operation.

The stated problem is solved by an agricultural harvesting machine which is characterized in that the camera is connected to an image evaluation device which can be operated to detect edges in the images that are produced, on the basis of which properties of the fragmented crop can be deduced.

The solution according to the invention is based on the finding that the quality of the fragmented crop can be determined only to a limited extent on the basis of the size distribution of particles present therein. It was recognized that, in order to improve the determination of quality, it is useful to search the fragmented crop specifically for components such as husk leaves, stalk pieces, whole corn kernels, and/or other feasible components that indicate, for instance, that fragmentation performed by the forage harvester is incomplete. In particular, if there are husk leaves or stalk pieces that extend substantially in a longitudinal direction, for example, they may pass through the chopping assembly aligned in parallel with the cutting edges of the chopping blades, with the possible consequence that they are not cut at all, or only in the longitudinal direction. In these cases, a length of cut selected on the basis of the feed rate and chopper drum speed is greatly exceeded.

According to the invention, an advantageous method for searching for crop components was found, in which the image evaluation device connected to the camera can detect edges in the camera images of the fragmented crop. It is based on the finding that edges of chopped material components that are visible in the image can be detected mechanically, which is an advantage, since the outlines (edges) of at least a few chopped material components in the generated image have a contrast compared to the remaining fragmented material that is pronounced and/or extends along a certain length. Furthermore, characteristic edge shapes enable the image evaluation device to ascribe them to various chopped material components. A relatively unambiguous identification can be made on the basis of the edge shape in the case of husk leaves, stalk pieces, or whole corn kernels, for example. Based on the edges detected in the image of the crop, the image evaluation device deduces, in a manner according to the invention, properties of the crop such as a portion of husk leaves, stalk pieces, or whole corn kernels present in the fragmented crop, thereby providing a differentiated quality assessment of the crop. The stated problem is therefore solved.

To detect edges of crop components that are visible in the generated image, it is advantageous that the image evaluation device searches for contrasts in the image that extend along a specifiable minimum length. It is thereby ensured that only crop material components of a certain size or greater are considered in the evaluation. The shape of the contrast (curved or straight) can also be utilized by the image evaluation device to make an assignment, according to which husk leaves or stalk pieces, in particular, have straight edge shapes and, therefore, straight contrast shapes, while corn kernels, for instance, can be recognized by their curved (approximately round) contrast shapes.

Accordingly, the image evaluation device can be advantageously operated to determine a portion of stalk pieces present in the crop on the basis of substantially straight edges that were detected, which is based on the fundamental idea that stalks or stalk pieces have long, high-contrast edges in the image.

Alternatively or in addition thereto, the image evaluation device can be advantageously operated to determine a portion of husk leaves present in the crop on the basis of substantially straight edges that were detected, since they have long, high-contrast edges in the image. To differentiate husk leaves from stalk pieces, the image evaluation device can consider further criteria such as the edge length, color, an area that was calculated, and other features detected in the image.

Alternatively or in addition thereto, the image evaluation device can be advantageously operated to determine a portion of corn kernels present in the crop on the basis of edge shapes that were detected. To this end, it is feasible to deduce the presence of an unfragmented corn kernel on the basis of an edge shape visible in the image, which is curved, closed in particular, and approximately round. On the basis of the edge shape it is furthermore feasible for the image evaluation device to calculate the size of the corn kernel, e.g. on the basis of a diameter of a closed edge shape that was detected.

According to an advantageous development of the invention, the forage harvester comprises an output device which can be operated to output information related to the ascertained properties of the crop to an operator of the harvesting machine. It can be any type of output (optical, acoustic, etc.).

The information can be structured differently in terms of content, or can serve different purposes. For example, the information could signal to the operator that a definable limit value of a crop property has been exceeded. In this case, the operator therefore receives information in the sense of a warning message or a signal if, for instance, a maximum quantity of husk leaves in the crop, which was defined previously by the operator, is detected in the crop. The operator can use such information to take action on his own to undo the overshooting of the limit value.

The information can also simply be the quantity of crop component present in the crop. In that case, the operator is notified via the output device of the quantity of crop component that was ascertained, wherein the quantity can be output as an absolute value or relative value (with reference quantity).

Moreover, according to a development of the invention, the information can contain a recommendation for the operator regarding machine settings that will improve the quality of the crop. In order to define a monitored quality of the crop, it is useful to state—on the basis of criteria to be entered in advance by the operator, or criteria that can be called up from a memory—that the recommendation that was provided be directed toward reaching the thusly defined quality.

To further simplify work during the harvesting operation, a further embodiment of the invention provides a control device connected to the image processing device, which actuates at least one working assembly of the harvesting machine, depending on properties of the crop that were ascertained, in order to improve the quality of the crop. It is therefore possible for the harvesting machine to react automatically to the crop properties that were ascertained, without the need for the machine operator to direct his attention thereto. Actuation of different working assemblies is feasible. It can also be provided that the operator is prompted to confirm the action before ail actuation is carried out, to prevent unwanted, automatic intervention by the machine.

Advantageously, the control device can be operated to change the length of cut of the crop depending on the portion of stalks detected in the crop. In the chopping process, the length of cut of the crop is determined in particular via the interaction of chopper drum speed and intake speed of the intake conveyor mechanism, wherein the length of cut shortens as the chopper drum speed increases or the intake speed decreases, while the particular other parameter is held constant.

Advantageously, by actuating the chopper drum and/or the intake conveyor mechanism accordingly, the control device brings about a shortening of the length of cut if the stalk portion in the crop increases, since this action allows the stalk portion to decrease.

Likewise advantageously, the control device can be operated to initiate or carry out an action that improves the cutting behavior of the chopping assembly depending on the portion of husk leaves detected in the crop. This idea can be implemented, for example, by the control device activating a sharpening device assigned to the chopping assembly, or a shear bar adjustment device assigned to the chopping assembly if a specifiable husk leaf portion in the crop is overshot, since this action can further reduce the portion of husk leaves.

Alternatively or in addition thereto, the control device can be operated to actuate—depending on the portion of corn kernels detected in the crop—a conditioning device disposed downstream of the chopping assembly in such a manner that a specifiable portion of corn kernels in the crop is not exceeded. In this case, the actuation should serve to obtain fewer non-fragmented corn kernels in the chopped material, or even none at all. Specifically, the actuation can involve changing the roller spacing of the cracker rollers of the conditioning device. In addition, the actuation could change the rotational speed difference of the cracker rollers, or change the compression force acting between the cracker rollers.

The invention is explained below in greater detail with reference to the attached figures and on the basis of an embodiment. Further details and advantages of the invention will become apparent therefrom.

### BRIEF DESCRIPTION OF THE DRAWINGS

FIG. 1 shows a schematic side view of a forage harvester according to the invention,

FIG. 2 shows a simplified, schematic view of an image of the fragmented crop, which was captured by the camera of the forage harvester according to the invention.

### DESCRIPTION OF THE PREFERRED EMBODIMENTS

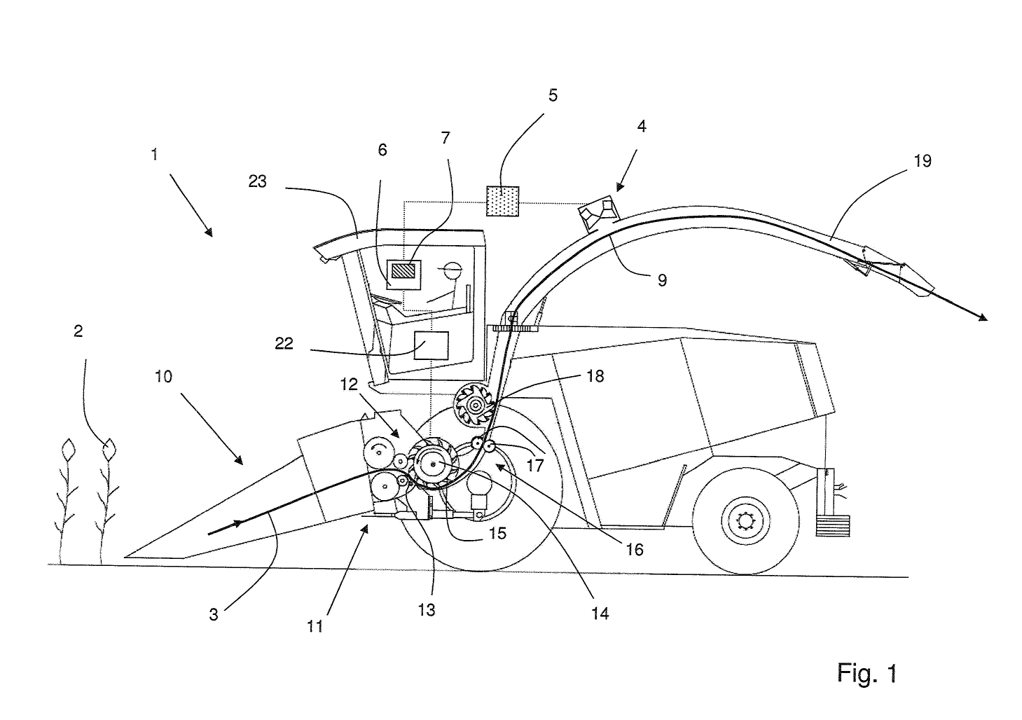

FIG. 1 shows a self-propelled agricultural harvesting machine in the form of a forage harvester 1. Forage harvester 1 comprises a front axle and rear axle (not depicted) with associated wheels, and is suited for driving across a field to harvest plant crop 2 indicated. A crop flow 3 conveyed through forage harvester 1 during the harvesting operation is indicated as a black line (in the direction indicated by arrows).

During harvesting operation, forage harvester 1 cuts plant crop 2 from the field using a front attachment 10, to direct the cut plant parts as crop flow 3 to downstream intake conveyor mechanisms 11 which comprise, inter alia, two pair of compression rollers with rotating compression rollers (not labeled individually) which precompress crop flow 3 to form a crop mat and convey it into a chopping assembly 12.

Chopping assembly 12 comprises mainly one rotating chopper drum 14 and a stationary shear bar 13 opposite thereto. Chopper drum 14 is equipped with a large number of cutting blades 15 and rotates in the counterclockwise direction during the harvesting operation, as shown in FIG. 1, in order to cut (“chop”) the crop in interaction with the stationary shear bar 13.

After fragmentation in chopping assembly 14, the crop passes through a conveyor chute 16 which rises behind a driver's cab 23. In conveyor chute 16, a conditioning device comprising two rotating conditioning rollers 17 and one post-accelerator 18 are disposed one behind the other relative to the direction of crop flow 3. Crop flow 3 passes between driving conditioning rollers 17, the frictional surfaces of which serve to break up corn kernels contained in the crop and thereby make them digestible by animals. Post-accelerator 18 serves to subsequently accelerate the crop to enable subsequent ejection via a transfer device 19 (“upper discharge chute”) adjacent to conveyor chute 16, out of forage harvester 1 to a hauling vehicle which is not depicted.

Due to highly diverse influencing factors such as, inter alia, changing harvesting conditions (crop type, moisture level of the crop, crop composition, etc.), changed settings or wear on machine components (forward-travel speed, length of cut, gap width of the conditioning rollers, knife sharpness, shear bar state or space, etc.), the quality of the ejected chopped material fluctuates considerably in part during the harvesting operation.

To enable the quality of the chopping process to be monitored, forage harvester 1 is equipped with a camera 4 which optically detects the crop processed in forage harvester 1 immediately before transfer to a hauling vehicle, to determine the quality. To this end, camera 4 is disposed downstream of all processing devices of forage harvester 1 relative to crop flow 3, and is disposed on a rear panel of transfer device 19. Fragmented crop 9 which is conveyed through transfer device 19 is detected optically by camera 4, wherein camera 4 produces images 5 (shown in a simplified manner as boxes) of fragmented crop 9. Due to the high conveying speed in transfer device 19 and the low light irradiation, camera 4 is advantageously also equipped with an illumination device (e.g. a stroboscope), as indicated, which emits flashes of light onto fragmented crop 9, for example, to enable evaluatable images 5 to be produced.

Camera 4 is connected via a signal line to an image evaluation device 6 in order to receive images 5 of fragmented crop 9 produced by camera 4. Image evaluation device 6 is capable of searching for edges 8 in images 5 that were received, in order to deduce properties of fragmented crop 9 therefrom.

According to the embodiment shown in FIG. 1, image evaluation device 6 comprises an optical output device 7 in the form of a display which is visible to a machine operator working in driver's cab 23. Via output device 7, properties of crop 9 ascertained by image evaluation device 6 are communicated to the machine operator. This can take place, for example, by indicating the quantity of a crop component detected in fragmented crop 9. In addition, recommendations can be delivered to the operator via output device 7 stating which machine settings or other actions can improve the quality of the chopped material.

According to the embodiment shown in FIG. 1, forage harvester 1 also includes a control device 22 connected via signals to image evaluation device 6. Depending on the properties of crop 9 that were ascertained, it enables automatic actuation of a working assembly of forage harvester 1 or the automatic initiation of any other action to improve the quality of crop 9. The actuation can change e.g. rotational speeds of intake conveyor mechanisms 11, chopper drum 14, conditioning rollers 17 (the speed ratio thereof, if applicable). In addition, the shear bar spacing and/or the conditioning roller gap could be changed via the actuation. It is also feasible to initiate a sharpening procedure of cutting blades 15.

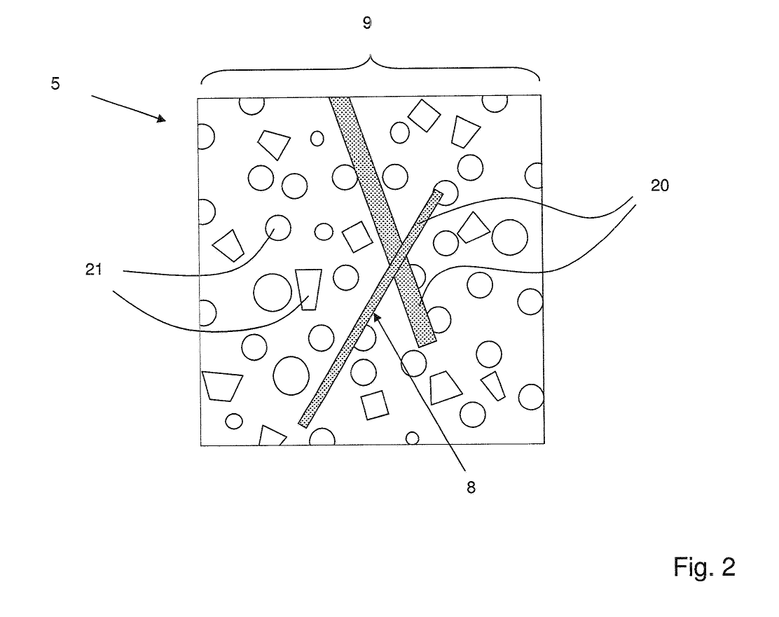

FIG. 2 shows, in a simplified schematic depiction, an image 5 of fragmented crop 9, which was taken with camera 4 of forage harvester 1. What is shown is fragmented crop 9 in an instantaneous picture as it “flies past” camera 4, from the perspective of camera 4 attached to the rear panel of transfer device 19 according to FIG. 1. According to FIG. 2, crop 9 depicted as an example is composed of various components, including a large number of particles 21 having different shapes and sizes, and two stalk pieces 20.

To deduce properties of crop 9, image evaluation device 6 detects edges 8 that are present in the section of crop 9 (image 5) that was ascertained. Advantageously, this takes place in that image evaluation device 6 searches for and identifies contrasts that exist in image 5, extend along a certain minimum length, and have a certain intensity, as is the case mainly along edges 8 of stalk pieces 20. Image evaluation device 6 can clearly assign stalk pieces 20 to the category of a stalk piece on the basis of the straight edge shape of stalk pieces 20 along a much longer length than is the case with particles 21. Depending on the number of stalk pieces that were identified in an image 5—even more exact statements can be made when a series of several images 5 is considered—, the image evaluation device 6 is capable of calculating a measure of frequency (e.g. the number of stalks per quantity of crop). It is therefore possible to output such information to the operator via an output device 7. Accordingly, machine adjustment measures can be carried out using control device 22, in order to automatically influence the properties of crop 9, if necessary.

In addition to the edge detection described, it is feasible for image evaluation device 6 to utilize other features contained in image 5 for evaluation. For example, edge detection can be advantageously combined with color evaluation.

It should be noted that an evaluation based on edge analysis was described for stalk pieces 20, as an example, although other crop components that have a characteristic shape that is recognizable by the shape of the edge can also be identified in a similar manner. This is the case with husk leaves, for example. It is likewise feasible to detect whole corn kernels in the crop, wherein a straight curve edge is not searched for in this case, but rather a closed, approximately round edge shape, possibly in combination with a measure of diameter. A combination with color evaluation can also be advantageous here, in particular since corn kernels differ from the rest of the crop components by the yellow color.

It will be understood that each of the elements described above, or two or more together, may also find a useful application in other types of constructions differing from the types described above.

While the invention has been illustrated and described as embodied in An agricultural harvesting machine, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. An agricultural harvesting machine, comprising a chopping assembly for fragmenting crop; a camera situated downstream of said chopping assembly and optically detecting the fragmented crop and producing images of the fragmented crop; and an image evaluating device connected with said camera and operating to detect edges in the produced images and to deduce properties of the fragmented crop.

2. The agricultural harvesting machine as defined in claim 1, wherein said image evaluation device is configured to search for contrasts that extend past a specifiable minimum length, for detecting the edges in the images that were produced.

3. The agricultural working machine as defined in claim 1, wherein said image evaluation device is configured to determine a portion of stalk pieces present in the crop on a basis of substantially straight edges that were detected.

4. The agricultural working machine as defined in claim 1, wherein said image evaluation device is configured to determine a portion of husk leaves present in the crop on a basis of substantially straight edges that were detected.

5. The agricultural working machine as defined in claim 1, wherein said image evaluation device is configured to determine a portion of corn kernels present in the crop on the basis of edge shapes that were detected.

6. The agricultural harvesting machine as defined in claim 1, further comprising an output device configured to output information relating to the properties of the crop that were ascertained to an operator of the harvesting machine.

7. The agricultural harvesting machine as defined in claim 6, wherein said output device configured to output information related to the properties of the crop that were ascertained to an operator of the harvesting device, which information signals to the operator that a definable limit value of a crop property has been overshot.

8. The agricultural harvesting machine as defined in claim 6, wherein said output device configured to output information relating to the properties of the crop that were ascertained to an operator of the harvesting machine, which information is a quantity of at least one crop component present in the crop material.

9. The agricultural harvesting machine as defined in claim 6, wherein said output device operates to output information relating to the properties of the crop that were ascertained to an operator of the harvesting machine, which information contains a recommendation for the operator regarding machine settings that will improve a quality of the crop.

10. The agricultural harvesting machine as defined in claim 1, further comprising a control device connected to said image evaluation device and actuating at least one working assembly of the harvesting machine, depending on properties of the crop that were ascertained for improving a quality of the crop.

11. The agricultural harvesting machine as defined in claim 10, wherein said control device is configured to change a length of cut of the crop depending on a portion of stalk pieces detected in the crop.

12. The agricultural harvesting machine as defined in claim 11, wherein said control device is configured to shorten a length of cut as the portion of stalk pieces increases.

13. The agricultural harvesting machine as defined in claim 10, wherein said control device is configured to initiate or carry out an action that improves a cutting behavior of said chopping assembly depending on a portion of husk leaves detected in the crop.

14. The agricultural harvesting machine as defined in claim 13, wherein said control device is configured to activate an element selected from the group consisting of a sharpening device assigned to said chopping assembly and a shear bar adjustment device assigned to said chopping assembly if a specifiable leaf portion in the crop is overshot.

15. The agricultural harvesting machine as defined in claim 10, further comprising a conditioning device which is actuated by said control device depending on a portion of corn kernels detected in the crop in such a manner that a specifiable portion of corn kernels in the crop is not exceeded.

16. The agricultural harvesting machine as defined in claim 15, wherein said conditioning device is disposed downstream of said chopping assembly.
